(19) United States
(12) Patent Application Publication
(10) Pub. No.: US 2016/0125606 A1
(43) Pub. Date: May 5, 2016

(54) Ultra-Low Power, Ultra High Thruput (ULTRA2) ASIC-based Cognitive Processor

(71) Applicants: James W. Justice, Newport Beach, CA (US); Medhat Azzazy, Laguna Niguel, CA (US); Virgillio Villacorta, Corona, CA (US); Xuemin Chi, Foothill Ranch, CA (US)

(72) Inventors: James W. Justice, Newport Beach, CA (US); Medhat Azzazy, Laguna Niguel, CA (US); Virgillio Villacorta, Corona, CA (US); Xuemin Chi, Foothill Ranch, CA (US)

(21) Appl. No.: 14/926,587

(22) Filed: Oct. 29, 2015

Related U.S. Application Data
(60) Provisional application No. 62/073,095, filed on Oct. 31, 2014.

(51) Int. Cl. G06T 7/00; G06K 9/00; G06T 1/20

(52) U.S. Cl. CPC G06T 7/0026; G06T 7/0034; G06T 1/20; G06K 9/00624; G06T 2207/20004; G06T 2207/20164

(57) ABSTRACT

There has been a significant advance in the capabilities of electro-optical sensors to search wide areas and provide data streams that contain information critical to system operators. The problem being addressed by this invention is the accurate and timely interpretation of the observations made by these sensor suites and the instantiation of the processing on practical low power, high throughput processors which enable deployment on a wide variety of platforms. The interpretation of sensor observations will also depend upon a) the general situation, e.g. level of hostility, and b) collateral data, e.g. normal or abnormal operations of the platforms themselves. Can accurate and timely situation awareness be achieved? Yes, humans do it all the time. Can it be done on small, ultra-low power, ultra-high throughput processors? Yes 3D stacked analog ASIC circuits enable such processors.

### CROSS-REFERENCE TO RELATED APPLICATIONS

This application claims the benefit of U. S. Provisional Patent Application No. 62/073,095 filed on Oct. 31, 2014 entitled “Ultra Low Power, Ultra High Throughput (ULTRA²) ASIC-based Cognitive Processor” pursuant to 35 USC 119, which application is incorporated fully herein by reference.

### STATEMENT REGARDING FEDERALLY SPONSORED RESEARCH AND DEVELOPMENT

NA

### BACKGROUND OF THE INVENTION

1. Field of the Invention

The invention relates generally to the field of image processing. More specifically, the invention relates to a device and method for identifying salient features in a scene by analyzing video image data of scenes which may be in the form of a plurality of spectral ranges in the electromagnetic spectrum which may include LWIR, SWIR, NIR, visible or any user-selected spectral ranges. User-selected attributes in the scene are identified by running a plurality of image processing algorithms on the image data which may be in the form of convolutions which in part, may emulate the image processing of the human visual cortex. The invention further encompasses the instantiation of the processing on very low power, very high throughput ASIC circuitry that may be in the form of 3 dimensional stacked electronic chip components.

2. Description of the Related Art

Image interpretation techniques have traditionally relied upon spatial and temporal analysis of the image content to determine the types of targets and target activities present. This processing is often in the form of Automatic Target Recognition (ATR) analyses wherein detailed models of targets are stored and compared to potential targets in the video data streams in order to determine the target types being observed. The shortcomings of such techniques results from the dynamic changes that affect video image content such as illumination level changes and viewing aspect changes. This approach has additional limitations that result from the heavy computational load required. Power and volume requirements of processors executing ATR functions prevent them from providing high confidence, near real-time evaluations and prevent them from being deployed on observation platforms of high interest such as manned and unmanned aircraft, autonomous land vehicles, and satellites.

While digital FPGAs and GPUs are providing advanced computational capabilities with greatly increased speed, they cannot meet the requirements of real-time exploitation in either throughput or power consumption for the ever increasing capabilities of modern video and reconnaissance/surveillance systems and the limitations of the platforms upon which they are based. Such digital systems fall several orders of magnitude short of desired power/throughput factors needed to process the data streams in real-time in on-board processors. These data streams are now so large that communication bandwidth limitations permit transmission of only a small fraction of available data thus significantly limiting real-time effectiveness. What is needed is a processing technique that can operate on massive video data streams in real-time, detect and classify key targets or objects of interest, and which can be instantiated on ultra-low power processors (Watts vs Kilowatts) with ultra-high throughput (TeraOPS vs GigaOPS). This disclosed invention accomplishes that goal.

### BRIEF SUMMARY OF THE INVENTION

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

There has been a significant advance in the capabilities of electro-optical sensors to search wide areas and provide data streams that contain information critical to system operators. The problem being addressed by this invention is the accurate and timely interpretation of the observations made by these sensor suites and the instantiation of the processing on practical low power, high throughput processors which enable deployment on a wide variety of platforms. The interpretation of sensor observations will also depend upon a) the general situation, e.g. level of hostility, and b) collateral data, e.g. normal or abnormal operations of the platforms themselves. Can accurate and timely situation awareness be achieved? Yes, humans do it all the time. Can it be done on small, ultra-low power, ultra-high throughput processors? Yes 3D stacked analog ASIC circuits enable such processors.

### BRIEF DESCRIPTION OF THE SEVERAL VIEWS OF THE DRAWINGS

The invention and its various embodiments can now be better understood by turning to FIGS. 1, 2, 3, 4, and 5 and the description of the preferred embodiments which are presented as illustrated examples of the invention in any subsequent claims in any application claiming priority to this application. It is expressly understood that the invention as defined by the claims may be broader than the illustrated embodiments described below.

FIG. 1 presents the cognitively inspired processing architecture that implements adaptive saliency processing of data from sensors that locates regions of potential interest in sensor data streams. FIG. 2 presents the addition of inference processing to the architecture which enables the saliency data to be interpreted in the context of the general situation and with collateral data inputs to derive situation assessments and threat determinations with their associated confidence levels. FIG. 3 provides an illustration of the analog circuitry required to execute the highly parallel cognitive processing architectures with extremely low power and very fast speeds. FIG. 4 provides an example of the 3 dimensional electronics chip stacking techniques which will enable the processing to be accomplished in compact processor designs. FIG. 5 provides an example of an analog ASIC-based, multi-element data processor enabled by 3 Dimensional electronic chip stacking that can 1) execute the cognitive processing architecture with ultra-low power (watts) and ultra-high throughput (TeraOPS) for very high pixel rate imaging sensor suites and 2) is Size, Weight and Power (SWaP) compatible with use on a wide spectrum of vehicles.

### DETAILED DESCRIPTION OF THE INVENTION

Turning now to the figures wherein like numerals define like elements among the several views, there has been a significant advance in the capabilities of electro-optical sensors to search wide areas and provide data streams that contain information critical to system operators. The problem being addressed by this invention is the accurate and timely interpretation of the observations made by these sensor suites and the instantiation of the processing on practical low power, high throughput processors which enable deployment on a wide variety of platforms. The interpretation of sensor observations will also depend upon a) the general situation, e.g. level of hostility, and b) collateral data, e.g. normal or abnormal operations of the platforms themselves. Can accurate and timely situation awareness be achieved? Yes, humans do it all the time. Can it be done on small, ultra-low power, ultra-high throughput processors? Yes 3D stacked analog ASIC circuits enable such processors.

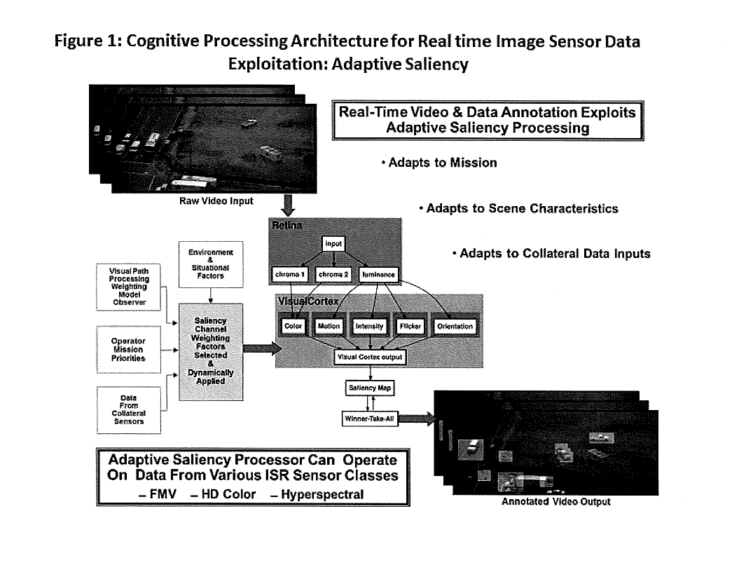

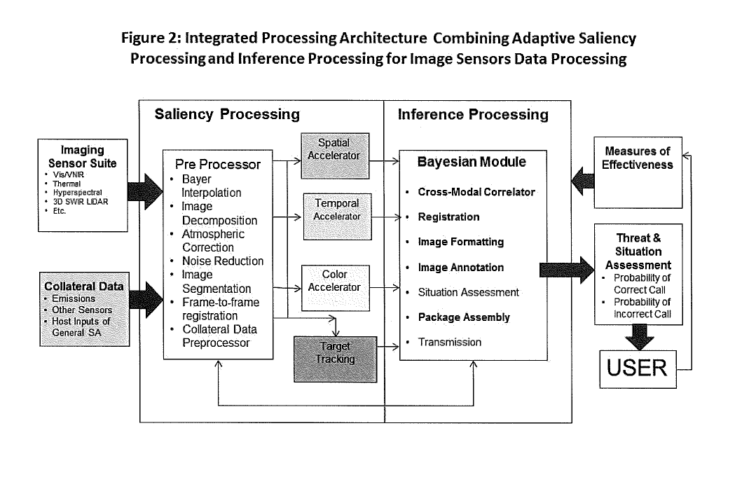

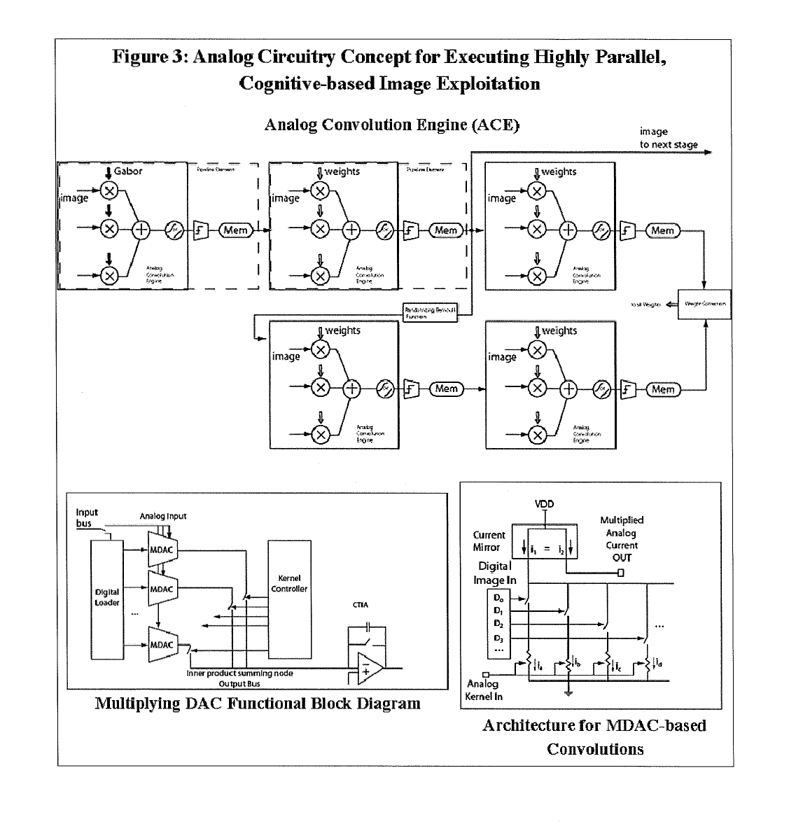

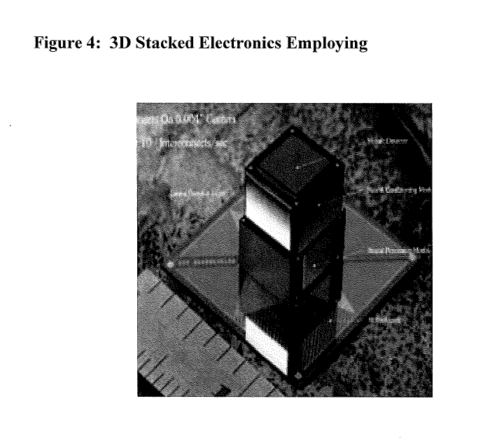

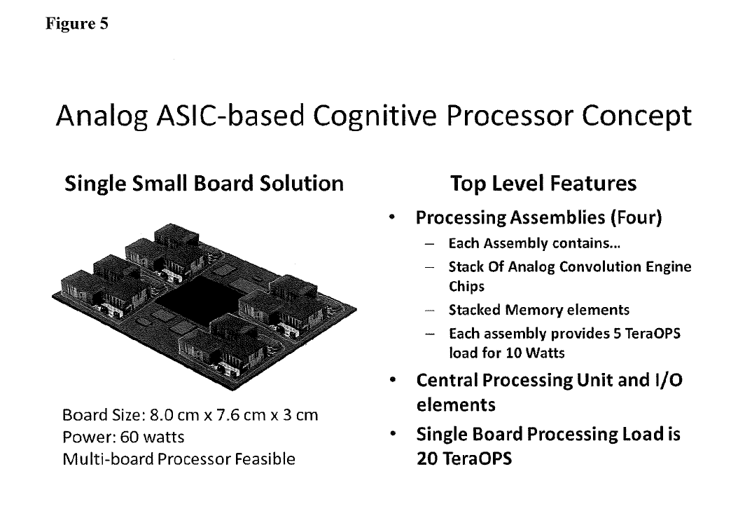

This invention models situation processing in a way that emulates the human situation awareness processing. The first key feature of the invention is the emulation in electronics of the human visual path saliency processing which examines massive flows of imagery data and determines areas of potential activity based on spatial, temporal, and color content. Extensions of neuroscience saliency models to include adaption to observing conditions, operational concerns and priorities, and collateral data is illustrated in FIG. 1. Saliency-based detection of activities of interest in the observed scenes and the characterization of the data within the areas of interest initiate the interpretive process.

The importance of particular activities is determined based on platform operational functions, viewing geometries, and the missions of the operators of sensor-bearing platforms. The data on the state of health of the platform and the collateral data about the general situation from outside sources are combined with the activity detection results in an inference model, which may be of Bayesian form. This is the second key feature of the invention. The inference model establishes the statistical relationships between the sets of data that are inputs to the model thus enabling decision making to be accomplished under conditions of observational uncertainty. This approach also enables the degree of confidence in the situation assessment to be determined. The saliency and inference processing engines are linked and provided with the mission priorities and with collateral data as illustrated in FIG. 2. Outputs of this integrated cognitive processing are compared to situational scenarios and an assessment of the situation is made and reported to platform operators. This technique is capable of highly accurate assessment because it is based on the full information content from sensors and the full situational context of the platform about which the situation awareness is being assessed.

In addition to the accuracy of the situation awareness assessments being performed, the timeliness of analysis is critical. The third key feature of the invention is the instantiation of the software/firmware realizations of the invention in analog processing elements that provide massively parallel computation capabilities at unconventionally low levels of power consumption. Unique features of the software/firmware are designed in to exploit this massively parallel computation capability. By operating in this manner, images can be divided into smaller segments and each processed for salient features in parallel. Temporal processing is accomplished in a similar parallel fashion. This achieves massive processing loads (many TeraOPS) enabling situation awareness and threat detection and classification analyses to be accomplished with negligible latency. The key feature of the analog circuit design is the exploitation of a multiplying digital to analog (MDAC) circuit feature which can be exercised to efficiently accomplish the convolutions required. These circuits are then architected to form an Analog Convolution Engine (ACE) as illustrated in FIG. 3.

FIG. 4 provides an example of the successful building of a 3D stack of analog circuits that execute high volumes of parallel processing with very low power consumption. FIG. 5 provides an embodiment of the invention by combining sufficient stacked analog processing circuit elements to achieve multi-TeraOPS processing loads.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. An image processing appliance comprising a family of processing functions instantiated on very high throughput, very low power processing elements that accomplishes real-time analysis of image data streams, detection, identification and extraction of important content, and interpretation of activities of objects of salient interest wherein the analysis functions accomplish a) determination of user-selected salient content based on spatial, temporal, and color correlations of scene objects, b) analysis of activities of salient objects within the image data streams, c) determination of the importance of salient object activities based on situational context of the activities and areas being observed.

2. Instantiation of the integrated processing architecture of claim 1 on analog ASIC chip sets arranged as three dimensional stacked processing units wherein the analysis functions are accomplished with negligible latency.

3. The image data streams of claim 1 in the form of a plurality of spectral ranges in the electromagnetic spectrum and may include UV, Visible, Near Visible, SWIR, MWIR, LWIR or any user selected spectral range.

4. The salient content detection capabilities of claim 1 accomplished by electronic emulation of models of how the human visual path determines the salient content of imagery observed by the eye and processed on the retina and in the early stages of image processing within the cortex involving types of spatial, temporal, and color correlation processing.

5. The saliency processing of claim 1 adaptive to user priorities, observing environmental conditions, and other collateral information affecting the user interests in real-time.

6. The saliency processing of claim 1 accomplished by use of an array of adaptive correlation circuits.

7. The analysis of salient object activities and the determination of their user importance of claim 1 accomplished in an inference model that describes the statistical relationships concerning the general nature of the data search objectives and the observing situations thus enabling event importance determinations to be made under conditions of observational uncertainty.

8. The integrated processing architecture of claim 1 as a merger of the saliency based image processing and the inference based data processing.

9. The saliency and inference processing of claim 1 as instantiated in arrays of adaptive correlation circuits on individual chips that are stacked into three dimensional (3D) stacked processing units.

10. Multiple 3D stacked processing units of claim 1 assembled into an integrated processing board arrangement combining processing control and management processing elements along with multiple 3D stacked ASIC processing elements.
